(19) United States
(12) Patent Application Publication
(10) Pub. No.: US 2026/0276099 A1
(43) Pub. Date: Sep. 17, 2026

(54) DIRECT DRIVE DUCT COOLED VALVE FOR FLUID METERING

(71) Applicant: Woodward, Inc., Fort Collins, CO (US)

(72) Inventors: Michael Stanley Morgan, Loveland, CO (US); Travis James Rodine, Livermore, CO (US); Jack Wernet, Park Ridge, IL (US); Mariusz K. Kuczaj, Chicago, IL (US); Timothy Noldte, Chicago, IL (US); Derek Ross Bean, Fort Collins, CO (US); Joseph Michael Sega, Timnath, CO (US)

(73) Assignee: Woodward, Inc., Fort Collins, CO (US)

(21) Appl. No.: 19/079,648

(22) Filed: Mar. 14, 2025

(51) Int. Cl. F16K 31/04; F16H 25/20; F16H 25/22

(52) U.S. Cl. CPC F16K 31/047

(57) ABSTRACT

An air valve line replaceable unit for an aircraft engine includes a flowbody housing with a fluid flow axis. An electro-mechanical actuator is positioned inboard of the flowbody housing and in line with the fluid flow axis and linearly translates a metering element. The rotor of the actuator is configured as a nut of a ballscrew arrangement that threadably engages a shaft having the metering element affixed thereto. Rotation of the rotor linearly translates the shaft and the metering element in a linear direction. Alternatively, an output shaft of the actuator is configured as a shaft of the ballscrew that threadably engages a nut to which the metering element is affixed. Rotation of the output shaft linearly translates the nut and the metering element. Cooling of the actuator is provided by fluid flow through the flowbody. Thermal insulation is provided by an air gap between the flowbody and the actuator.

### FIELD OF THE INVENTION

This invention generally relates to fluid flow control devices for aircraft engines, and more particularly to air valve line replaceable units (LRUs) and actuators therefor for use on aircraft engines.

### BACKGROUND OF THE INVENTION

Components that are used to control fluid flow in aircraft engines are typically temperature sensitive devices that have operational temperature limits. The operational temperature limits drive either the location of the devices or dictate the required cooling of them. This is especially true for air valve LRUs which are often installed at locations on the engine that correspond to high temperature environments.

Typical fueldraulic actuators in service on modern aircraft engines utilize a continuous flow of fuel as a cooling medium to maintain the actuator temperature in such a high temperature environment. However, for installations that require or may simply desire the use of an electro-mechanical actuator (EMA) instead of a fueldraulic actuator, the ability to use fuel as a cooling fluid is eliminated. As a result, such LRUs using an EMA must have an alternative source of cooling or be capable of operating in the high temperature environment of the engine without cooling.

Compounding the design requirements for normal operation in such high temperature environments, installation on the aircraft engine may also subject the EMA to temperatures well above the normal operating environment during, e.g., an engine fire event or engine soakback when the aircraft engine is shut down after landing. Such increased temperature requirements also pose a significant technical challenge to EMAs.

Typical methodologies used to account for this increased temperature requirement utilize devices that provide thermal insulation against fire and soakback temperatures. Unfortunately, such devices are fragile and increase both the cost and weight of the actuator, making them undesirable solutions to protect against the high temperature environments in which air valve LRUs operate.

Further weighing against the usage of an EMA as an alternate actuator solution to a fueldraulic actuator are the EMA's overall weight, size, and vibration response. Specifically, EMA-based alternatives to fueldraulic actuators typically require mechanical geartrains or other electrical-to-mechanical power conversion devices that increase the size, weight, and complexity of the actuator. For example, certain embodiments described in U.S. Pat. No. 11,713,813, entitled Inline Variable Sonic Valve, filed Jan. 3, 2022, and assigned to the assignee of the instant application, the entire teachings and disclosure of which are hereby incorporated in their entireties for all purposes by reference thereto, illustrate this increased complexity and positioning of the EMA. While providing certain clear benefits, such increase and effects of the positioning nonetheless may result in an unfavorable comparison to current fueldraulic actuators for certain applications.

Still further, the location of the additional weight and positioning of the volume for such geartrains or other power conversion devices in pedigree LRUs is remote from their support structures. Unfortunately, such increased weight and volume location resulting from the use of an EMA in turn drives the requirement for the use of enhanced support structures, which further increase the weight of the overall LRU assembly beyond the EMA component penalty itself.

The foregoing and other design challenges have thus far limited the application of an EMA to the air valve LRUs used on aircraft engines in place of or as supplemental to the current fueldraulic actuators. Nonetheless, because of certain advantages that may be provided by such EMAs, and/or to overcome certain disadvantages or prohibitions of using fueldraulic actuators, there is a need in the art for a new and improved EMA-based air valve LRU for use on aircraft engines. Embodiments of the present invention provide such EMA-based air valve LRUs for use on aircraft engines.

These and other advantages of the invention, as well as additional inventive features, will be apparent from the description of the invention provided herein.

### BRIEF SUMMARY OF THE INVENTION

In view of the foregoing, embodiments of the present invention provide a new and improved air value line replaceable unit (LRU) that overcomes one or more of the problems discussed above. More particularly, embodiments of the present invention provide a new and improved air value LRU that utilizes an electro-magnetic actuator (EMA) to control the valving member of the air valve. Still more particularly, embodiments of the present invention provide a new and improved air value LRU that utilizes an EMA that is positioned inboard of the flowbody housing and in line with the fluid flow through the LRU.

Such in line positioning allows for the fluid metered therethrough to provide cooling of the EMA. Further, such inboard positioning allows the exterior wall of the LRU to provide additional thermal protection for the EMA from temperatures well above the normal operating environment during, e.g., an engine fire event or engine soakback when the aircraft engine is shut down after landing. Still further, such positioning in line and within the LRU reduces the overall volume of the LRU while decreasing the vibration and mounting structure issues discussed above.

Embodiments of the present invention address the previously described issues by integrating a direct drive EMA actuator into the LRU housing that facilitates cooling of the EMA components using the working fluid. In certain embodiments, the EMA is located in line with a poppet valve at the centerline of the flow, which provides the duct cooling of the EMA. Preferably, the EMA is located inside the flowbody portion of the LRU housing with duct fluid flow directly contacting a portion or all of the EMA housing. Contact with the fluid flowing through the air valve LRU provides cooling for the actuator.

Further, the gap between the outer housing/flowbody skin of the LRU and the EMA housing provides insulation against the high temperature environment and from a fire event or during engine soakback. Advantageously, this protection against external high temperature environments does not depend on fluid flowing through the air valve LRU due to the size of the gap between the LRU skin and EMA housing. As a result of the inboard EMA, the LRU can operate in environments up to and potentially more severe than the prior fueldraulic solutions.

As mentioned briefly above, containing the EMA inboard of the flowbody also reduces the weight and volume of the LRU and provides improved vibration response of the LRU. Further, because the valve is primarily supported by the end flanges, embodiments of the present invention having the inboard actuator eliminate a cantilevered actuator. Locating the EMA inside the LRU housing also provides optimized support of the EMA. Current actuators are only supported from a single surface/plane of the flowbody and often extend beyond that surface creating an unsupported cantilever that responds unfavorably to vibration input, which drives additional weight and volume. Conversely, the internal EMA of certain embodiments of the present invention are affixed by numerous supports on any side of the actuator. This reduces weight of the supports and enables optimization of the supports to the specific vibration environment of the LRU.

In certain embodiments of the present invention, the EMA motor is directly connected to the poppet metering element without the use of gearing. In certain embodiments for use in low pressure drop applications, no gearbox is needed, which enables the direct drive of the metering element shaft with a ballscrew to convert the rotational motion of the motor to the linear motion of the metering element. Such embodiments provide certain benefits for such translational valve design, e.g., the pressure of the fluid flow through the flowbody assists in closing the valve. The extra force provided by the flow assists in back driving the motor and in turn reduces the size of the failsafe spring mechanism used in certain embodiments. The direct drive reduces weight and volume of the LRU by eliminating components typically included in an EMA valve design.

Embodiments of the present invention provide various advantages over the current state of the art, which include enabling mounting of LRU with EMA actuation in more severe environments, improved reliability of electronics due to active cooling, does not require cooling flow other than the working fluid, improved vibration response, improved fire and high soakback temperature resistance, and reduced envelope.

In one embodiment, an air valve line replaceable unit (LRU) includes a housing having an inlet flange and an outlet flange defining a flowbody housing therebetween having a fluid flow axis, an electro-mechanical actuator (EMA) positioned inboard of the flowbody housing and in line with the fluid flow axis, and a poppet valve having a metering element linearly translated by the EMA to meter fluid flow through the flowbody housing.

In an embodiment, the EMA includes a motor and a ballscrew arrangement. Preferably, the motor is a brushless direct current (BLDC) motor. In other embodiments, the motor may be an AC motor powered from the AC power available on the engine.

In an embodiment, the motor of the EMA includes a rotor configured to serve as a nut of the ballscrew arrangement that threadably engages a shaft of the ballscrew arrangement. The metering element of the poppet valve is affixed to one end of the shaft. Rotation of the rotor in a first rotary direction linearly translates the shaft and the metering element affixed thereto in a first linear direction, and rotation of the rotor in a second rotary direction opposite the first rotary direction linearly translates the shaft and the metering element affixed thereto in a second linear direction opposite the first linear direction.

In another embodiment, the motor of the EMA includes an output shaft configured to serve as a shaft of the ballscrew arrangement that threadably engages a nut of the ballscrew arrangement. The metering element of the poppet valve is affixed to the nut. Rotation of the output shaft of the motor of the EMA in a first rotary direction linearly translates the nut and the metering element affixed thereto in a first linear direction, and rotation of the output shaft of the motor of the EMA in a second rotary direction opposite the first rotary direction linearly translates the nut and the metering element affixed thereto in a second linear direction opposite the first linear direction.

In an embodiment a plurality of EMA supports are coupled between an inner surface of the flowbody housing and an outer surface of a housing of the EMA and configured to maintain a position of the EMA in line with the flow axis. In certain embodiments, one of the EMA supports is configured as a conduit providing electrical connection from an electrical connector to the EMA. In a further embodiment, a thermal insulating air gap is formed between the inner surface of the flowbody housing and the outer surface of a housing of the EMA.

In an embodiment, the EMA also includes a return spring configured to linearly translate the metering element of the poppet valve to a failsafe position upon loss of electric power to the EMA. Preferably, the metering element is configured such that a pressure resulting from fluid flow impinging on a windward face of the metering element assists the return spring to linearly translate the metering element to the failsafe position.

In an embodiment, the metering element defines a pass-through orifice configured to allow a minimum flow through the flowbody housing when the poppet valve is closed. In certain embodiments, the LRU also includes a manual override and lockout mechanism configured to position and hold the poppet valve to the closed position.

In another embodiment, a method of utilizing an electro-mechanical actuator (EMA) to control a position of a valving member of an aircraft engine mounted air valve line replaceable unit (LRU) having a flowbody housing defining a fluid flow axis therethrough, includes the steps of positioning the EMA inboard of the flowbody housing and in line with the fluid flow axis and linearly translating a valving element of the air valve by the EMA.

In an embodiment, the method also includes the step of cooling the EMA with fluid flowing through the flowbody housing when the air valve is open. In certain embodiments, the step of positioning includes the step of creating a thermal insulating air gap between the flowbody housing and the EMA to protect the EMA from high temperatures outside of the flowbody housing at least when the air valve is closed.

In an embodiment wherein the EMA includes a motor and a ballscrew arrangement, the step of linearly translating the valving element of the air valve by the EMA includes the steps of configuring a rotor of the motor of the EMA to serve as a nut of the ballscrew arrangement that threadably engages a shaft of the ballscrew arrangement, affixing the metering element to one end of the shaft, rotating the rotor in a first rotary direction to linearly translate the shaft and the metering element affixed thereto in a first linear direction, and rotating the rotor in a second rotary direction opposite the first rotary direction to linearly translate the shaft and the metering element affixed thereto in a second linear direction opposite the first linear direction. In a further embodiment, the method also includes the step of applying a spring force to linearly translate the shaft and the valving element affixed thereto to a failsafe position upon loss of electric power to the motor of the EMA.

In another embodiment wherein the EMA includes a motor and a ballscrew arrangement, the step of linearly translating the valving element of the air valve by the EMA includes the steps of configuring an output shaft of the motor of the EMA to serve as a shaft of the ballscrew arrangement that threadably engages a nut of the ballscrew arrangement, affixing the metering element to the nut, rotating the output shaft of the motor of the EMA in a first rotary direction to linearly translate the nut and the metering element affixed thereto in a first linear direction, and rotating the output shaft of the motor of the EMA in a second rotary direction opposite the first rotary direction to linearly translate the nut and the metering element affixed thereto in a second linear direction opposite the first linear direction. In a further embodiment, the method also includes the step of applying a spring force to linearly translate the nut and the valving element affixed thereto to a failsafe position upon loss of electric power to the motor of the EMA.

In an embodiment, the step of positioning the EMA inboard of the flowbody housing and in line with the fluid flow axis includes the step of positioning the EMA upstream of the valving element of the air valve such that pressure of the fluid flow through the flowbody housing acts on the valving element to linearly translate the valving element to a failsafe position upon loss of electric power to the motor of the EMA.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view illustration of a flow through integrated direct drive poppet valve constructed in accordance with an embodiment of the present invention shown with a comparison envelope of a prior EMA or fueldraulic actuator and air valve LRU;

FIG. 2 is a downstream end view illustration of the flow through integrated direct drive poppet valve of FIG. 1 shown with a comparison envelope of the prior EMA or fueldraulic actuator and air valve LRU;

FIG. 3 is a cross-sectional illustration of the flow through integrated direct drive poppet valve of FIG. 1 taken through a plane as indicated in FIG. 2;

FIG. 4 is a cross-sectional illustration of the flow through integrated direct drive poppet valve of FIG. 1 taken through a plane rotated 90° relative to FIG. 3 as indicated in FIG. 2;

FIG. 5 is a side view illustration of an in line streamlined poppet valve having an electromechanical actuator (EMA) constructed in accordance with another embodiment of the present invention;

FIG. 6 is a bottom view illustration of the in line streamlined poppet valve having an electromechanical actuator (EMA) of FIG. 5;

FIG. 7 is an end view illustration of the in line streamlined poppet valve having an electromechanical actuator (EMA) of FIG. 5; and

FIG. 8 is a cross-sectional illustration of the in line streamlined poppet valve having an electromechanical actuator (EMA) of FIG. 5 rotated about the cut-line shown in FIG. 6 by 90°.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there are illustrated various embodiments of air valve line replaceable units (LRUs) utilizing electro-mechanical actuators (EMAs) for use on aircraft engines constructed in accordance with the teachings of the present invention. However, those skilled in the art will recognize from the description herein that the applications for such LRUs are not limited only for use on aircraft engines, although the many benefits provided by these embodiments are particularly apparent in such harsh operating environments. As such, the descriptions herein should be taken by way of example and not by way of limitation.

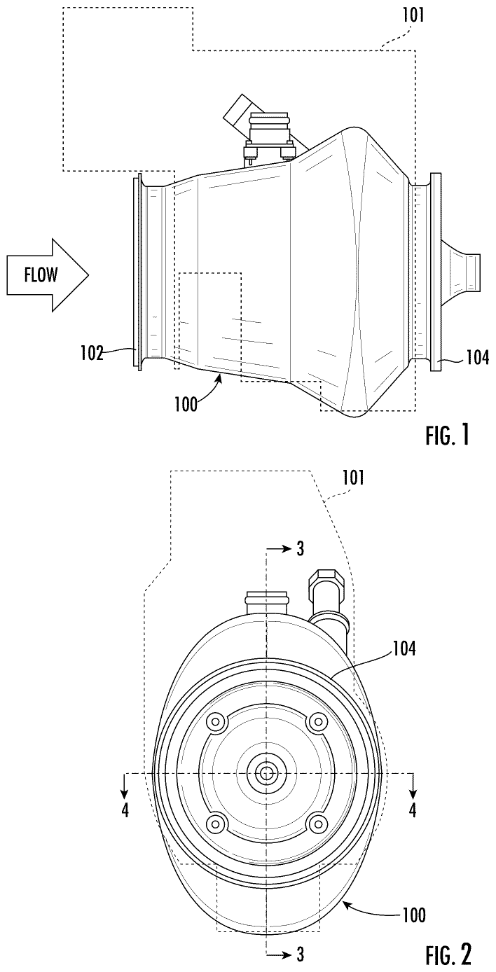

Before discussing details of the various embodiments of the present invention, attention is directed to FIGS. 1 and 2, which illustrate an exemplary envelope volume reduction achieved by one embodiment of an air valve LRU 100 of the present invention as compared with a prior, externally mounted, EMA or fueldraulic actuator and air valve LRU envelope volume 101. Of particular note is the volume of the prior LRU 101 that is located above the flanges 102, 104 without support. Such unsupported volume of the cantilevered actuator of the EMA, and the weight associate therewith, are at least part of the reason for the vibration issue discussed above that drives the requirement for enhanced mounts, which further adds to the weight issues also discussed above.

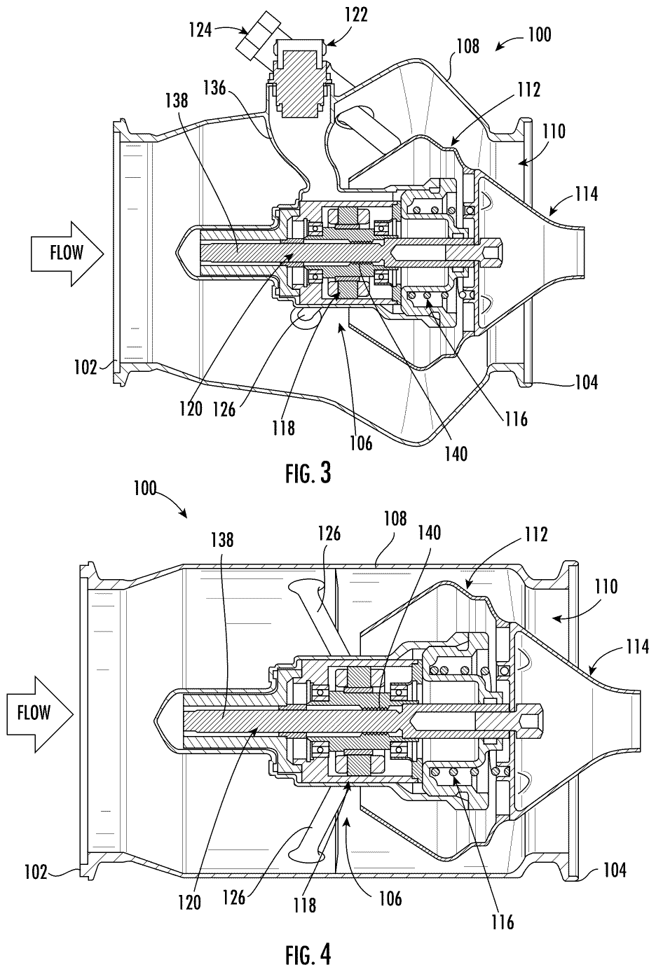

These issues are overcome in part by the location of the EMA 106 inboard of the housing 108 and in line with the poppet valve 110 at the centerline of the fluid flow through the LRU 100 as shown in the cross-sectional illustrations of FIGS. 3 and 4 to which attention is now directed.

In the orientation illustrated in both FIGS. 3 and 4, the working fluid flow enters from the left end through the inlet flange 102 and exits the LRU 100 through the outlet flange 104. Because the EMA 106 is positioned in line with the fluid flow axis through the LRU 100, the working fluid directly impinges on the housing of the EMA 106. This impinging fluid flow provides the cooling of the EMA 106 during operational modes that have fluid flowing through the LRU 100.

However, during operational modes or conditions when the EMA 106 translates the metering elements 112, 114 of the poppet valve 110 to the right to close the air valve by seating against the interior surface of the air valve housing 108 prior to the outlet flange 104, there is no fluid flow to cool the EMA 106. Instead, the inboard positioning of the EMA 106 provides thermal insulation from the high temperature environment outside of the housing 108 of the LRU 100 by the airgap between the housing of the EMA 106 and the interior of housing 108. Indeed, this airgap also provides thermal protection against extreme high-temperature situations, e.g., an engine fire or engine soakback, during both flow and no flow conditions through the LRU 100.

The positioning and support of the EMA 106 within the housing 108 of the air valve LRU 100 is accomplished by EMA supports 126, the numbering and position of which may vary depending on the vibrational requirements of a particular installation. Further, in certain embodiments the conduit 136 through the housing 108 of the LRU 100 through which electrical connection from the electrical connector 122 to the motor 118 of the EMA 106 also provides support to the EMA 106. As a result, the overall weight of the EMA supports 126 is reduced compared with the prior EMA or fueldraulic based LRU 101.

This positioning of the EMA 106 inboard of the housing 108 of the LRU 100 and in line with the flow axis of the poppet valve 110 allows the EMA to directly drive the poppet valve 110 without the need for any gearbox. Instead, the motor 118, illustrated in the present embodiment as a brushless DC motor, may directly drive a shaft 138 of a ballscrew arrangement 120 to position the metering elements 112, 114 of the poppet valve 110.

Specifically, the rotor of motor 118 serves as the nut 140 of the ballscrew arrangement 120 and threadably engages the shaft 138 of the ballscrew arrangement 120 such that rotation of the nut (rotor) 140 in one direction linearly translates the shaft 138 of the ballscrew 120 and the metering elements 112, 114 affixed to a distal end thereof to the right. Rotation of the rotor (nut 140) of motor 118 in the opposite direction linearly translates the shaft 138 of the ballscrew 120 and the metering elements 112, 114 affixed thereto to the left. This direct drive allows for a less complex design that efficiently transfers the rotary motion of the motor 118 to linear translation of the metering elements 112, 114 of the poppet valve 110 to meter the flow of fluid through the air valve LRU 100.

This in line positioning also provides the advantage of allowing for a reduced size return spring 116 used to close the poppet valve 110 if electrical power is lost to the motor 118. This is because the flow of the working fluid through the air valve LRU 100 asserts pressure on the metering element 112, which aids in back driving the motor 118 to translate the poppet valve metering elements 112, 114 to the closed position (movement to the right in the orientation of FIGS. 3 and 4). This flow pressure reduces the force required to be exerted by the return spring 116, thereby allowing it to be sized accordingly to further reduce the overall weight of the LRU 100.

Such in line, direct-drive design also allows a manual override and lockout mechanism 124 to position the poppet valve 110 to a closed position, which is also aided by the return spring 116.

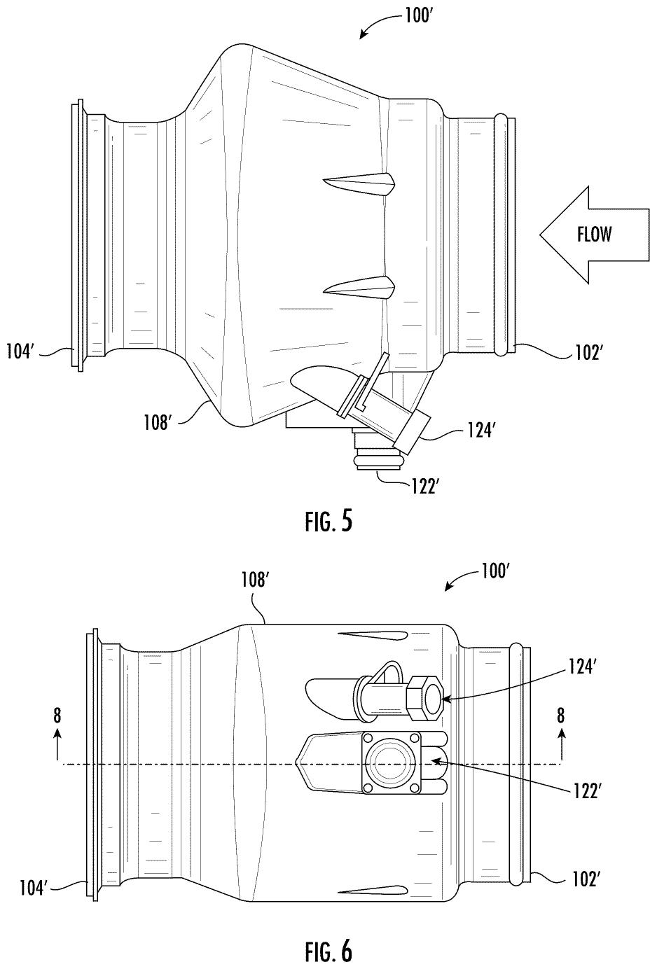

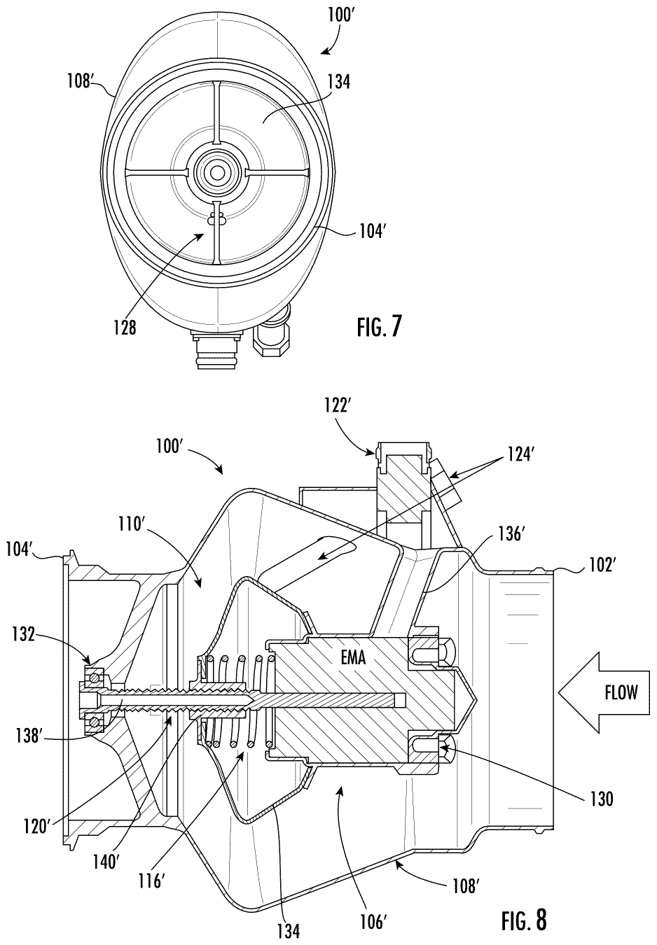

An alternative embodiment of an air valve LRU 100′ is illustrated in FIGS. 5-8, which utilizes similar components designated with the same reference numeral as the prior embodiment with the addition of an ′, albeit in a different internal configuration as best seen in the cross-sectional illustration of FIG. 8. Also, while not shown in the illustrations of the prior embodiment, the end view of FIG. 7 illustrates a pass-through orifice 128 that allows for pressure equalization across the metering element 134 of the poppet valve 110′ and a minimum flow through the air valve LRU 100′ during operational modes or phases when the poppet valve 110′ is closed.

In the orientation illustrated in FIGS. 5-8, the working fluid flow enters from the right end through the inlet flange 102′ and exits the LRU 100′ through the outlet flange 104′. Because the EMA 106′ is positioned in line with the fluid flow axis through the LRU 100′, the working fluid directly impinges on the housing of the EMA 106′. This impinging fluid flow provides the cooling of the EMA 106′ during operational modes that have fluid flowing through the LRU 100′.

However, during operational modes or conditions when the EMA 106′ translates the metering element 134 of the poppet valve 110′ to the left to close the air valve by seating against the interior surface of the air valve housing 108′ prior to the outlet flange 104′, there is no fluid flow to cool the EMA 106′, or in embodiments including the pass-through orifice 128, only minimal flow. Instead, the inboard positioning of the EMA 106′ provides thermal insulation from the high temperature environment outside of the housing 108′ of the LRU 100′ by the airgap between the housing of the EMA 106′ and the interior of housing 108′. Indeed, this airgap also provides thermal protection against extreme high-temperature situations, e.g., an engine fire or engine soakback, during both flow and no flow conditions through the LRU 100′.

The positioning and support of the EMA 106′ within the housing 108′ of the air valve LRU 100′ is accomplished by EMA supports (not visible in the cross-section of FIG. 8), the numbering and position of which may vary depending on the vibrational requirements of a particular installation. Further, in certain embodiments the conduit 136′ through the housing 108′ of the LRU 100′ through which electrical connection from the electrical connector 122′ to the motor of the EMA 106′ also provides support to the EMA 106′. As a result, the overall weight of the EMA supports is reduced compared with the prior EMA or fueldraulic based LRU 101.

This positioning of the EMA 106′ inboard of the housing 108′ of the LRU 100′ and in line with the flow axis of the poppet valve 110′ allows the EMA to directly drive the poppet valve 110′ without the need for any gearbox. Instead, the EMA 106′ output shaft 138′ is threaded to linearly translate the nut 140′ of the ballscrew arrangement 120′ to which the metering element 134 of the poppet valve 110′ is affixed. However, in another embodiment, the EMA 106′ includes a planetary gear set to increase the output torque of the motor to rotate the ball screw output shaft 138′.

As may be seen in the cross-sectional illustration of FIG. 8, a spanner cap 130 is used to secure the EMA 106′ in position within the housing 108′ of the LRU 100′. Like the prior embodiment, the fluid flow through the air valve LRU 100′ applies pressure to the metering element 134 in aid with the return spring 116′ to position the metering element 134 in its closed or failsafe position upon the loss of electrical power to the EMA 106′. Similarly, a manual override and lockout 124′ may be used to similarly position the metering element 134, also aided by the return spring 116′.

Unlike the prior embodiment, however, the metering element 134 is affixed to the nut 140′ that is threadably coupled to the shaft 138′ of the ballscrew 120′, which shaft 138′ is rotated by the EMA 106′. Rotation of the shaft 138′ of the ballscrew arrangement 120′ in one direction linearly translates the metering element 134 to the left, while rotation of the shaft 138′ of the ballscrew 120′ in an opposite direction linearly translates the metering element 134 to the right. Because the shaft 138′ of the ballscrew 120′ itself is not linearly translated through the EMA 106′ as with the prior embodiment, the distal end of the shaft 138′ of the ballscrew 120′ is supported by ball bearings 132 proximate to the outlet flange 104′.

This direct drive also allows for a less complex design that efficiently transfers the rotary motion of the shaft 138′ of the ballscrew 120′ to linear translation of the metering element 134 of the poppet valve 110′ to meter the flow of fluid through the air valve LRU 100′.

This in line positioning also provides the advantage of allowing for a reduced size return spring 116′ used to close the poppet valve 110′ if electrical power is lost to the EMA 106′ as mentioned above. This is because the flow of the working fluid through the air valve LRU 100′ asserts pressure on the metering element 134, which aids in back driving the EMA 106′ to translate the poppet valve metering element 134 to the closed position (movement to the left in the orientation of FIGS. 5-8). This flow pressure reduces the force required to be exerted by the return spring 116′, thereby allowing it to be sized accordingly to further reduce the overall weight of the LRU 100′.

Such in line, direct-drive design also allows a manual override and lockout mechanism 124′ to position the poppet valve 110′ to a closed position, which is also aided by the return spring 116′.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An air valve line replaceable unit (LRU), comprising:
a housing having an inlet flange and an outlet flange defining a flowbody housing therebetween having a fluid flow axis;
an electro-mechanical actuator (EMA) positioned inboard of the flowbody housing and in line with the fluid flow axis; and
a poppet valve having a metering element linearly translated by the EMA to meter fluid flow through the flowbody housing.

2. The LRU of claim 1, wherein the EMA comprises a motor and a ballscrew arrangement.

3. The LRU of claim 2, wherein the motor of the EMA includes a rotor configured to serve as a nut of the ballscrew arrangement that threadably engages a shaft of the ballscrew arrangement, wherein the metering element of the poppet valve is affixed to one end of the shaft, and wherein rotation of the rotor in a first rotary direction linearly translates the shaft and the metering element affixed thereto in a first linear direction, and wherein rotation of the rotor in a second rotary direction opposite the first rotary direction linearly translates the shaft and the metering element affixed thereto in a second linear direction opposite the first linear direction.

4. The LRU of claim 2, wherein the motor of the EMA includes an output shaft configured to serve as a shaft of the ballscrew arrangement that threadably engages a nut of the ballscrew arrangement, wherein the metering element of the poppet valve is affixed to the nut, and wherein rotation of the output shaft of the motor of the EMA in a first rotary direction linearly translates the nut and the metering element affixed thereto in a first linear direction, and wherein rotation of the output shaft of the motor of the EMA in a second rotary direction opposite the first rotary direction linearly translates the nut and the metering element affixed thereto in a second linear direction opposite the first linear direction.

5. The LRU of claim 2, wherein the EMA further comprises a planetary gear set coupled between the motor and the ballscrew arrangement to increase the torque from the motor to drive the ballscrew arrangement.

6. The LRU of claim 2, wherein the motor is one of a brushless direct current (BLDC) motor or an AC motor.

7. The LRU of claim 1, further comprising a plurality of EMA supports coupled between an inner surface of the flowbody housing and an outer surface of a housing of the EMA and configured to maintain position of the EMA in line with the flow axis.

8. The LRU of claim 7, wherein one of the EMA supports is configured as a conduit providing electrical connection from an electrical connector to the EMA.

9. The LRU of claim 7, wherein a thermal insulating air gap is formed between the inner surface of the flowbody housing and the outer surface of a housing of the EMA.

10. The LRU of claim 1, wherein the EMA further comprises a return spring configured to linearly translate the metering element of the poppet valve to a failsafe position upon loss of electric power to the EMA.

11. The LRU of claim 10, wherein the metering element is configured such that a pressure resulting from fluid flow impinging on a windward face of the metering element assists the return spring to linearly translate the metering element to the failsafe position.

12. The LRU of claim 1, wherein the metering element defines a pass-through orifice configured to allow a minimum flow through the flowbody housing when the poppet valve is closed.

13. The LRU of claim 1, further comprising a manual override and lockout mechanism configured to position and hold the poppet valve to the closed position.

14. A method of utilizing an electro-mechanical actuator (EMA) to control a position of a valving member of an aircraft engine mounted air valve line replaceable unit (LRU) having a flowbody housing defining a fluid flow axis therethrough, comprising the steps of:
positioning the EMA inboard of the flowbody housing and in line with the fluid flow axis; and
linearly translating a valving element of the air valve by the EMA.

15. The method of claim 14, further comprising the step of cooling the EMA with fluid flowing through the flowbody housing when the air valve is open.

16. The method of claim 14, wherein the step of positioning includes the step of creating a thermal insulating air gap between the flowbody housing and the EMA to protect the EMA from high temperatures outside of the flowbody housing at least when the air valve is closed.

17. The method of claim 14, wherein the EMA includes a motor and a ballscrew arrangement, wherein the step of linearly translating the valving element of the air valve by the EMA comprises the steps of:
configuring a rotor of the motor of the EMA to serve as a nut of the ballscrew arrangement that threadably engages a shaft of the ballscrew arrangement,
affixing the metering element to one end of the shaft,
rotating the rotor in a first rotary direction to linearly translate the shaft and the metering element affixed thereto in a first linear direction, and
rotating the rotor in a second rotary direction opposite the first rotary direction to linearly translate the shaft and the metering element affixed thereto in a second linear direction opposite the first linear direction.

18. The method of claim 17, further comprising the step of applying a spring force to linearly translate the shaft and the valving element affixed thereto to a failsafe position upon loss of electric power to the motor of the EMA.

19. The method of claim 14, wherein the EMA includes a motor and a ballscrew arrangement, wherein the step of linearly translating the valving element of the air valve by the EMA comprises the steps of:
configuring an output shaft of the motor of the EMA to serve as a shaft of the ballscrew arrangement that threadably engages a nut of the ballscrew arrangement,
affixing the metering element to the nut,
rotating the output shaft of the motor of the EMA in a first rotary direction to linearly translate the nut and the metering element affixed thereto in a first linear direction, and
rotating the output shaft of the motor of the EMA in a second rotary direction opposite the first rotary direction to linearly translate the nut and the metering element affixed thereto in a second linear direction opposite the first linear direction.

20. The method of claim 19, further comprising the step of applying a spring force to linearly translate the nut and the valving element affixed thereto to a failsafe position upon loss of electric power to the motor of the EMA.

21. The method of claim 14, wherein the EMA includes a motor coupled through a planetary gear set to drive a shaft of a ballscrew arrangement, wherein the step of linearly translating the valving element of the air valve by the EMA comprises the steps of:
affixing the metering element to a nut of the ballscrew arrangement,
rotating the output shaft of the motor of the EMA in a first rotary direction to linearly translate the nut and the metering element affixed thereto in a first linear direction, and
rotating the output shaft of the motor of the EMA in a second rotary direction opposite the first rotary direction to linearly translate the nut and the metering element affixed thereto in a second linear direction opposite the first linear direction.

22. The method of claim 14, wherein the step of positioning the EMA inboard of the flowbody housing and in line with the fluid flow axis comprises the step of positioning the EMA upstream of the valving element of the air valve such that pressure of the fluid flow through the flowbody housing acts on the valving element to linearly translate the valving element to a failsafe position upon loss of electric power to the motor of the EMA.
